(19) United States
(12) Patent Application Publication
(10) Pub. No.: US 2007/0050966 A1
(43) Pub. Date: Mar. 8, 2007

(54) Method and an apparatus for the creation of a tangible item, such as a tool and/or a part, and a tangible item

(75) Inventor: Mark Manuel, Shelby Township, MI (US)

Correspondence Address: BROOKS KUSHMAN P.C., 1000 TOWN CENTER, TWENTY-SECOND FLOOR, SOUTHFIELD, MI, 48075, US

(73) Assignee: FloodCooling Technologies, L.L.C., Bloomfield Hills, MI (US)

(21) Appl. No.: 11/546,634

(22) Filed: Oct. 11, 2006

Related U.S. Application Data
(63) Continuation of application No. 10/794,011, filed on Mar. 5, 2004.

(51) Int. Cl. B23P 25/00; B23P 11/00

(52) U.S. Cl. 29/514; 29/458; 29/505

(57) ABSTRACT

An apparatus and a methodology 200, 350 for producing a tangible item 120 by the use of a plurality of sectional members, such as sectional members 10 and 14. In one embodiment, each sectional member 14 includes a protuberance 16 and these protuberances are selectively nestled to allow the various sectional members 14 to be connected and to cooperatively form a tangible item, such as tangible item 120. In an alternate embodiment of the invention, a first sectional member includes an opening 12 which receives a protuberance 70 from another sectional member. Other sectional members may thereafter be coupled to this assembly by the use of nestled protuberances, thereby allowing the coupled sectional members to cooperatively create a tangible item.

### CROSS-REFERENCE TO RELATED APPLICATIONS

This is a continuation of copending application Ser. No. 10/794,011 filed on Mar. 5, 2004.

### FIELD OF THE INVENTION

The present invention generally relates to a method and an apparatus for the creation of a tangible item, such as a tool and/or a part and more particularly, by way of example and without limitation, to a method and an apparatus which allows such a tangible item to be made by the use of separately formed members which may be selectively joined to cooperatively form the desired tangible item. The present invention also relates to a new and novel tangible item created by a new and novel joining process or methodology.

### BACKGROUND OF THE INVENTION

It is known that a tool, such as a mold or a die, may be produced by selectively attaching sections or members in a manner which allows these sections or members to cooperatively form the desired mold or die (e.g., by the use of an adhesive). One such process, which may be referred to as a “laminate process”, is described within U.S. Pat. No. 6,587,742 B2 (hereinafter referred to as “The '742 Patent”) which is fully and completely incorporated herein by reference, word for word and paragraph for paragraph and which is assigned to Applicants' assignee. Particularly, in one such a laminate type process, the various sectional members are formed and sequentially attached to form a desired tool or mold.

While these prior processes do allow for the selective creation of a die, mold, or tool, they have certain respective aspects which may be improved upon. By way of example and without limitation, it is oftentimes difficult to cause a large number of sectional members to properly and cooperatively produce a large tool. Such difficulty lies in the variable and often unequal amount of compression which occurs within and/or between each of the sectional members (e.g., as the various sectional members are compressed as they are attached together to form the desired tool or mold). It should be appreciated that such compression is necessary in order to reduce the probability that the created tangible item will later be distorted or twist from handling or during operation, and to ensure the overall integrity of the created tool or mold (i.e., to increase the overall strength of the cooperative interconnection). Such difficulty further lies in the variable and often unequal amount and type of twist or physical distortion which occurs in some or all of the coupled sectional members, and the structural deformity occurring due to the technique used to actually and physically align the sectional members prior to joining them in a cooperative fashion (i.e., oftentimes it is very difficult to properly align each of the sectional members in the required fashion and such misalignment may cause malfunction, poor overall performance, and actually cause and/or contribute to a decrease in the overall integrity or strength of the cooperative connection required to create the. desired tool, die, or mold). Further, due to the large number of sectional members, small alignment errors occurring in the joining of some or all of these members (e.g., misalignments which may be caused by structural imperfections within or upon the various sectional members) as well as other errors, caused by such phenomena as compression and distortion, accumulates or compounds, thereby causing a tool to be produced which is undesirable and which is of a physical form which is undesirable (i.e., has undesirable spatial dimensions).

Approaches which have been used to address these issues requires physically joining each adjacent pair of sectional members by the use of an adhesive, by brazing, and/or by welding. While these approaches do allow sectional members to be selectively joined, they do not fully address the previously described difficulty. That is, each of these techniques increase the cost and complexity of the overall tool building process and increases the potential for causing further misalignment or damage to the overall constructed tool. Additionally, the adhesive normally has to be at least partially removed and the tool “cleaned” after it is constructed, thereby further increasing the complexity of the overall tool building process and these “joining strategies” do not precisely provide a consistent connection having consistent geometric and spatial attributes (e.g. one welded or adhesive connection may be “thicker” than another or have a non-uniform thickness), thereby further contributing to undesired misalignment. Further, these connections (especially an adhesive connection) may have spatial attributes which change over time (e.g., as the adhesive “dries out”, the connection may become non-uniform in thickness and actually cease to function, thereby causing the tool, die, or mold to fail).

Hence, these above-delineated drawbacks in combination with the lack of a technique or strategy to adequately address these drawbacks has caused the use of the lamination process to be practically used to build smaller tools and to be of rather limited use in building other types of complex tangible items (e.g., parts having a greatly varying or complex shape).

### SUMMARY OF THE INVENTION

It is a first non-limiting advantage of the present invention to provide a method and an apparatus for the creation of a tangible item.

It is a second non-limiting advantage of the present invention to provide a method and an apparatus for the creation of a tangible item which overcomes many, if not all, of the above-delineated drawbacks associated with existing lamination processes.

It is a third non-limiting advantage of the present invention to provide a method and an apparatus for the creation of a tangible item which may have a greatly varying size and shape.

It is a fourth non-limiting advantage of the present invention to provide a method and an apparatus for the creation of a tangible item which may have a greatly varying size and shape and which allows for the use of separately designed and constructed sectional members to cooperatively form the tangible item in a cost efficient and relatively accurate manner.

It is a fifth non-limiting advantage of the present invention to provide a new and novel tangible item made by a new and novel process which allows for the creation of tangible item by the use of a plurality of sectional members.

According to a first non-limiting aspect of the present invention, an apparatus is provided for creating a tangible item from the use of first and second sectional members. Particularly, the apparatus includes a first portion which selectively forms a first protuberance within the first sectional member, the first protuberance having a certain first diameter, the first portion further forming a second protuberance within the second sectional member, the second protuberance having a second diameter which is smaller than the certain first diameter; and a second portion which causes the second protuberance to be selectively nestled and to frictionally fit within the first protuberance.

According to a second non-limiting aspect of the present invention, an apparatus for creating a tangible item from the use of first and second sectional members is provided. Particularly, the apparatus includes a first portion which forms a hole within the first sectional member; and a second portion which form a first protuberance within the second sectional member, the first protuberance being adapted to be selectively and frictionally fit within the formed hole.

According to a third non-limiting aspect of the present invention, a methodology for forming a tangible item is provided. Particularly, the methodology includes the steps of forming a first sectional member; forming a second sectional member; forming a first protuberance within the first sectional member; forming a second protuberance within the second sectional member; and causing the second protuberance to be selectively fit within the first protuberance, thereby joining the second sectional member to the first sectional member and forming the tangible item.

According to a fourth non-limiting aspect of the present invention, a methodology for forming a tangible item is provided. Particularly, the methodology includes the steps of forming a first sectional member; forming a second sectional member; forming a hole within the first sectional member; forming a protuberance within the second sectional member; placing the protuberance within the formed hole, thereby joining the second sectional member to the first sectional member and forming the tangible item.

According to a fifth non-limiting aspect of the present invention, a tangible item is provided. Particularly, the tangible items includes a first sectional member in which a protuberance has been formed; and a second sectional member having a second protuberance which is selectively nested within the protuberance of the first sectional member, thereby joining the second sectional member to the first sectional member and forming the tangible item.

According to a sixth non-limiting aspect of the present invention, a tangible item is provided. Particularly, by way of example and without limitation, the provided tangible item includes a first sectional member having an opening; and a second sectional member having a protuberance which is selectively inserted into the opening of the first sectional member, thereby joining the second sectional member to the first sectional member and forming the tangible item.

According to a seventh non-limiting aspect of the present invention, a tangible item having a first sectional member including a targeted portion; and a second sectional item having an insertion portion which is selectively placed within the targeted portion and which cooperates with the targeted portion to allow the second sectional member to be automatically aligned with and be coupled to the first sectional member.

These and other features, aspects, and advantages of the present invention will become apparent by a review of the following detailed description of the preferred embodiment of the invention and by-reference to the following drawings.

### BRIEF DESCRIPTION OF THE DRAWINGS

FIG. 1 is a top view of a sectional member, made in accordance with the teachings of a first preferred embodiment of the inventions, which may be selectively used to make a tangible item in accordance with the teachings of the disclosed inventions;

FIG. 2 is a top view of a sectional member, made in accordance with the teachings of a second preferred embodiment of the inventions, which may be selectively used to make a tangible item in accordance with the teachings of the disclosed inventions;

FIG. 3 is a partial side view of a tangible item made in accordance with the teachings of the disclosed inventions and utilizing the sectional member which is shown in FIG. 1 and the sectional member which is shown in FIG. 2;

FIG. 4 is a partial side view of a tangible item made in accordance with the teachings of the disclosed inventions and utilizing sectional members, which are each generally similar to that sectional member which is shown in FIG. 2;

FIG. 5 is a partial side view of a tangible item which is made in accordance with the teachings of the disclosed inventions and using a connection strategy in accordance with the teachings of an alternate embodiment of the inventions;

FIG. 6 is perspective view of one non-limliting example of a tangible item made in accordance with the teachings of the inventions;

FIG. 7 is a flow chart including steps which cooperatively comprise a first tangible item creation methodology of the present inventions;

FIG. 8 is a flow chart including the steps which cooperatively comprise a second tangible item creation methodology of the present inventions; and

FIG. 9 is a side view of a protuberance forming device which may be used by the various disclosed inventions.

### DETAILED DESCRIPTION OF THE PREFERRED EMBODIMENT OF THE INVENTION

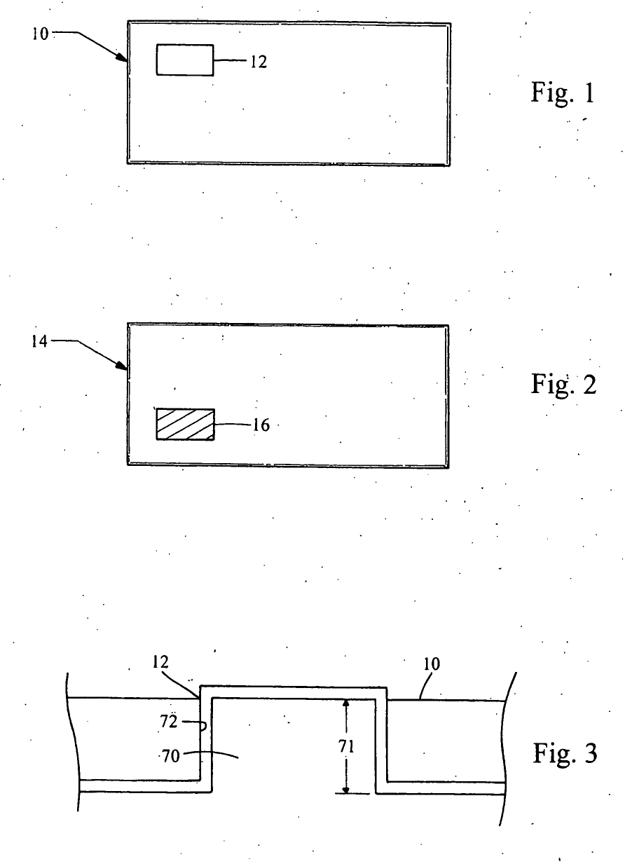

Referring now to FIG. 1, there is shown a sectional member 10 which is made in accordance with the teachings of the preferred embodiment of the invention. Particularly, it should be appreciated that sectional member 10 may be of substantially any desired shape and size (i.e., of any desired geometric configuration) and that nothing in this description is meant or should be construed to limit that size, shape, or geometric configuration of the sectional member 10 in any manner whatsoever. The term “sectional member” may mean a tangible item which has spatial properties (e.g., size and shape) derived from a model of an overall desired tangible item to be produced and which is adapted to be selectively coupled to another sectional member to cooperatively form the desired overall tangible item. Such sectional member may be made by a similar process to that which is shown and described within the '742 Patent.

According to the teachings of the present invention and as perhaps best shown in FIG. 1, the sectional member 10 includes an opening 12. It should be appreciated that opening 12 may be of substantially any desired size, shape, or geometric configuration and that nothing in this description is meant to limit the opening to a certain size, shape, or geometric configuration.

Referring now to FIG. 2, there is shown a second sectional member 14 which is made in accordance with the teachings of the preferred embodiment of the invention and which may used, as will be explained later, with the sectional member 10. By way of example and without limitation, member 14 may be created in a similar manner to member 66 of the '742 Patent. It should be appreciated that nothing in this description is meant or shall be construed as limiting the sectional member 14 to a certain size, shape, or geometric configuration. Further, as shown perhaps best in FIG. 2, the sectional member 14 includes a protuberance 16 which may of substantially any desired shape, size, or geometric configuration and that nothing in this description is meant to limit or fix the size, shape, or geometric configuration of the protuberance 16 in any manner whatsoever. As is more fully set forth below, a tangible item may be selectively created by the use of sectional members 10, 14 according to various methodologies of the present invention which are fully set forth below.

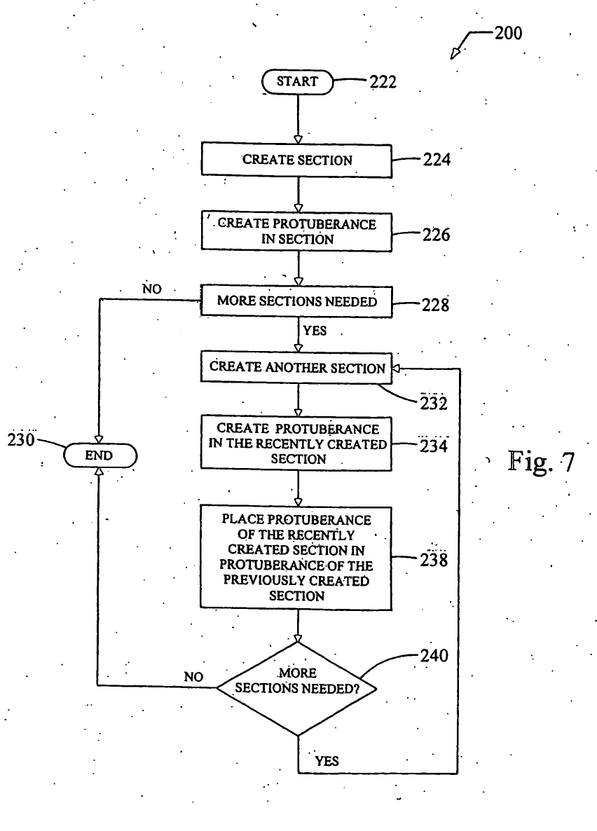

Referring now to FIG. 7, there is shown a tangible item creation methodology 200 which is made in accordance with the teachings of the preferred embodiment of the invention. Particularly, methodology 200 includes a first step 222 which defines or delineates the “start” of the overall tangible item creation process. By way of example and without limitation, in this first or “start” step 222, the various processors or machines which are used to perform the various steps of the methodology 200 may be initialized or made ready to begin the delineated methodology. Alternatively, the “start” step 222 is used to simply and conveniently delineate the beginning of the overall methodology.

Step 222 is followed by step 224 in which a first sectional member is created. This sectional member may be created by the use of the section creation methodology which is set forth within the '742 Patent or by the use of any other desired section creation methodology. The created section may be of any desired shape, size, or geometric configuration and nothing in this description is meant or shall be construed to limit the size, shape, or geometric configuration of this section to a particular type.

Step 224 is followed by step 226 in which a protuberance is created within the created sectional member. Such a protuberance may be of substantially any desired size, shape, or geometric configuration and nothing in this description shall be construed or is meant to be construed to limit the created protuberance to a particular size, shape, or geometric configuration. Hence, at the conclusion of step 226 of methodology 200, a sectional member which is substantially similar to sectional member 14 is created.

Step 226 is followed by step 228 in which a determination is made as to whether additional sectional members are needed to construct the desired tangible item. If no further sectional members are needed to construct the desired tangible member, step 228 is followed by step 230 in which the process or methodology 200 is concluded. Alternatively, step 228 is followed by step 232 in which another sectional member is created according to a desired sectional member creation methodology. In this regard, step 232 may be substantially similar to the previously described step 224.

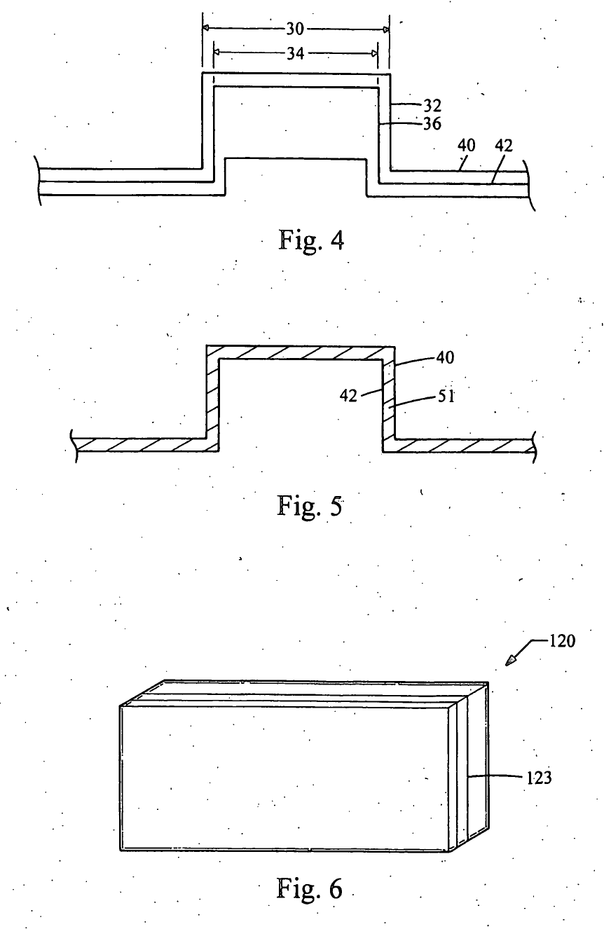

Step 232 is followed by step 234 in which a protuberance is selectively created within this second created section. This created protuberance, within step 234, may be substantially similar to the protuberance which is created within step 226. In one non-limiting embodiment of the invention, the diameter 30 of the first protuberance 32 is slightly larger than the diameter 34 of the second protuberance 36 (see FIG. 4). Step 234 is followed by step 238 in which the second formed protuberance 36 is frictionally fit and nestled within the first formed protuberance 32 in the manner shown, by way of example and without limitation, in FIG. 4. In this manner, the first formed sectional member 40 is connected or otherwise coupled to the second formed sectional member 42. Hence, the first formed protuberance 32 may be thought of as a “target portion” and the second formed protuberance 36 may be thought of as an “insertion portion”. Step 238 is followed by step 240 in which a determination is made whether additional sectional members are needed. If no additional sectional members are needed, step 240 is followed by step 230. Alternatively, step 240 is followed by step 232.

It should be appreciated that created sectional members, such as sectional members 40, 42 are joined in the manner shown, by way of example and without limitation, in FIG. 4. That is, in one non-limiting embodiment, a protuberance of a sectional member is inserted into the protuberance of the sectional member to which it is joined. In this manner, the sectional members may selectively and cooperatively form any desired tangible item, including a part, tool, or other item and these protuberances allow the various sectional members to be easily aligned. Further, in yet another non-limiting embodiment of the invention, the respective diameters of each protuberance are of a slightly different size. That is, the “outermost” protuberance (e.g., protuberance 32) which is not nestled into any other protuberance is the largest. The diameter of the protuberance which selectively nestles within the outermost protuberance is slightly smaller than the diameter of the outermost protuberance, thereby allowing the nestled protuberance to be frictionally engaged within the protuberance of the outermost sectional member. Similarly, an inserted protuberance has a diameter which is slightly smaller than the protuberance to which it is inserted and these slightly dissimilar protuberances enhance the strength and viability of the connection of the various sectional members. Thus, the protuberances, such as protuberance 16, allow for an automatic or self-alignment of the sectional members to occur. That is, once an insertion portion is placed within a targeted portion, the two respective sectional members (i.e., the one having the target or targeted portion and the one having the insertion portion) are “automatically” aligned (e.g., the term “automatically” may mean, in one non-limiting embodiment, that no physical intervention is needed to effectuate the alignment of these two sectional members 32, 36 once the targeted portion receives the insertion portion). Hence, the protuberances allow the two sectional members 32, 36 to be “self-aligning” (e.g., without additional manual intervention to effectuate the alignment process).

In yet another non-limiting embodiment of the invention, as best shown in FIG. 5, adhesive 51 may be selectively placed between each pair of adjacently joined sectional members, such as sectional members 40, 42, to further enhance the overall integrity of the connection. Alternatively, the adhesive 51 may be replaced by a welded and/or brazed type of connection. In yet another non-limiting embodiment, only the formed protuberances are connected with adhesive and/or a brazed or welded connection. Further, it should be appreciated that a wide variety of implements may be used to create these protuberances, such as protuberances 32, 36, and such implements may include a punch device, a robotic assembly, or a similar device. Further, in yet another non-limiting embodiment of the various inventions, methodology 200 may be modified so as to cause a protuberance to be created in the same step in which the sectional member is created upon which the protuberance is formed. That is, a protuberance is not created in a previously formed sectional member; rather the protuberance is created as part of the overall sectional member creation process.

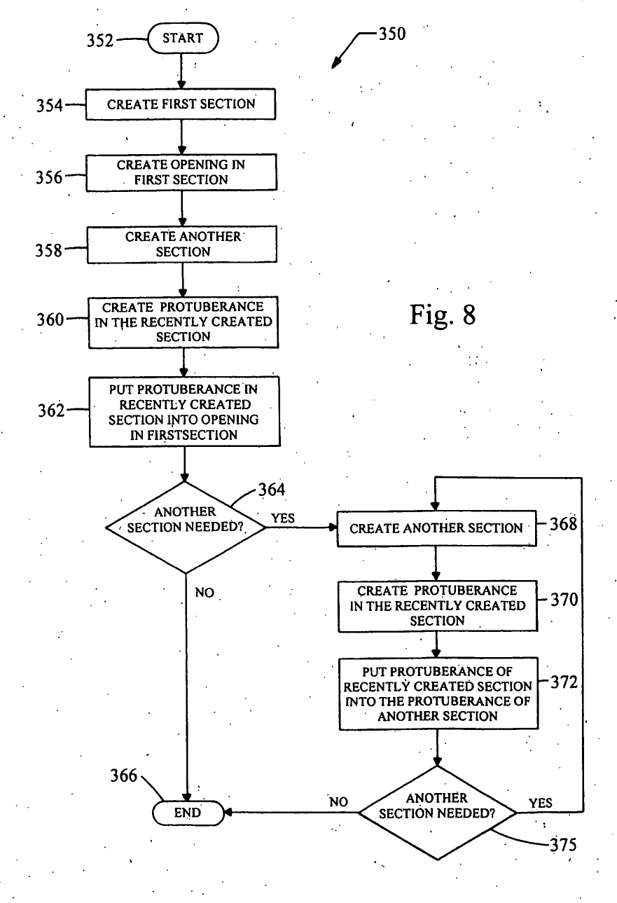

Referring now to FIG. 8, there is shown a methodology 350 which comprises an alternate methodology of the various inventions. Particularly, the methodology 350 includes a first or initial step 352 which delineates the “start” of the overall process and in which the machines or other equipment which may be used within the process or methodology 350 is initialized. Step 352 is followed by step 354 in which a first sectional member is created by a desired process such as, but not limited to, the sectional member creation process which is set forth in The '742 Patent. Step 356 follows step 354 and, in this step 356, an opening is created in this first section, by the use of a punch or other device or process. In this manner, the created or formed sectional member may be substantially similar to sectional member 10 which is shown and previously described with respect to FIG. 1. Thus, the created opening may be of substantially any desired size and shape and nothing in this description is meant or shall be construed as limiting the opening to any particular geometric configuration.

Step 358 follows step 356 and, in this step 358, another sectional member is created by a desired sectional member creation process such as, but not limited to, that which is described within the '742 Patent. Step 360 follows step 358 and, in this step 360, a protuberance is created in the recently created sectional member and this protuberance may of substantially any desired shape and geometric configuration. Nothing in this description is meant to limit the geometric configuration of the formed protuberance to a particular configuration. Step 362 follows step 360 and, in this step 362, the formed protuberance is made to fit through the formed opening (e.g., the formed opening may be thought of as the “target or targeted portion” and the formed protuberance may be thought of as the “insertion portion”). For example, as perhaps is best shown in FIG. 3, the formed protuberance 70 may pass slightly through the opening 12 in the first formed sectional member 10 (e.g. to a length of about one sixteenth to about one quarter of the overall length 71 of the formed protuberance, although other lengths of emanation may be used). In an alternate embodiment of the invention, adhesive may be used to couple or fix the protuberance 70 within the opening 12 or the protuberance 70 may be brazed and/or welded to the side portion 72 of the sectional member 10 which bounds the opening 12.

Step 364 follows step 362 and, in this step 364, it must be determined whether another sectional member must be created. If no other sectional member must be created (i.e., the desired tangible item may be formed by only the previously formed pair of sectional members), then step 364 is followed by step 366 in which the process or methodology 350 is ended. Alternatively, step 364 is followed by step 368 in which another sectional member is created by a desired sectional member creation process. Step 368 is followed by step 370 in which a protuberance is created within this newly formed sectional member, and step 370 is followed by step 372. Particularly, in step 372 the protuberance of this recently (third) formed sectional member is frictionally nestled within the protuberance formed within the second sectional member, thereby joining the third sectional member to the second sectional member. Such connection may be enhanced by the use of an adhesive or by a welded or brazed connection. In an alternate embodiment of the invention, the diameter of the protuberance of this third sectional member is slightly smaller than the diameter of the protuberance of the second sectional member, thereby allowing or enhancing the frictional fit and connection between these two adjacently coupled sectional members. Similarly, in the alternate non-limiting embodiment, the diameter of a protuberance which is selectively nestled within another protuberance is slightly smaller than the diameter of the receiving protuberance, thereby enhancing the overall integrity and strength of the connection scheme.

Step 372 is followed by step 375 in which it is determined whether another sectional member is to be created. If no other sectional member is to be created, than step 372 is followed by step 366. Alternatively, step 375 is followed by step 368.

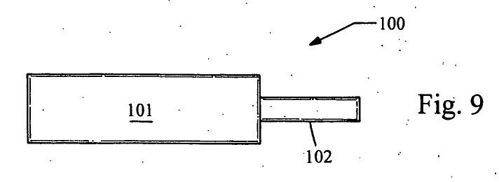

As shown best in FIG. 9, a punch device, such as punch device 100, may be used to selectively create protuberances and/or openings within formed sectional members. Particularly, the punch device 100 includes a body 101 and a end portion 102 which strikes the sectional member in the vicinity of the desired location for the protuberance. Such striking may be done by an individual or a robotic assembly. Material deposition processes may be used to create the protuberances and chemical etching processes may also be used to create the required openings.

Further, in yet another alternate embodiment of the invention, only a single step need to occur for the formation of a sectional member having a desired opening or protuberance.

Referring now to FIG. 6, there is shown a tangible item 120 which is made by the use of various sectional members 123 according to either methodology 200 or methodology 350. It should be apparent that the tangible item 120 may have substantially any desired geometric shape and configuration and that nothing in this description is meant to limit the shape, size, and/or geometric configuration of the tangible item 120 to a particular type.

It should be understood that the present invention is not limited to the exact construction or methodology which has been delineated above, but that various changes and modifications may be made without departing from the spirit and the scope of the inventions as are delineated in the following claims. Hence, it should be appreciated that the use of such an automatic or self-aligning strategy reduces the likelihood of undesirable misalignment which allows a large number of sectional members to be utilized in the production of a desired tangible item and that even complex items, such as an automobile part or another item having a greatly varying shape. Further, the improved alignment allows large amounts of compression to be desirably utilized to ensure the integrity of the produced tangible item without causing undesirable effects related to the misalignment error and the “self alignment” or “automatic alignment” features reduce overall costs and ensure the production of tangible items having desirable features. The placement of the insertion portions into the targeted portions may be achieved by the use of the tool 100 may be done manually or by a robotic assembly.

What is claimed is:

1. A method of forming a laminated die comprising:
forming a plurality of laminate metal sheets that when stacked together define at least a portion of a die with a near net shape work surface;
stamping at least two depressions in one side each of the plurality of laminate metal sheets, thereby forming a corresponding projection formed on the immediate other side thereof;
stacking in aligned orientation the plurality of laminate metal sheets with the projections and depressions aligned in a nested orientation after the depressions have been stamped; and
securely bonding the stacked and aligned laminate metal sheets together using a bonding agent.

2. The method of claim 1 further comprising machining the near net shape die surface.

3. The method of claim 1 further comprising securely bonding the stacked and aligned laminate metal sheets together by an adhesive.

4. The method of claim 1 further comprising brazing the stacked and aligned laminate metal sheets together.

5. The method of claim 1 further comprising welding the stacked and aligned laminate metal sheets together.

6. The method of claim 1 further comprising causing each projection to be frictionally fit within the corresponding aligned depression.

7. The method of claim 1 further comprising sizing each projection larger than the corresponding aligned depression so that each projection is frictionally fit within the corresponding aligned depression.

8. The method of claim 1 further comprising stamping the at least two depressions into a generally cylindrical shape.

9. A method for forming a laminated die comprising the steps of:
forming a first sectional member;
forming a second sectional member;
forming a first protuberance within said first sectional member;
forming a second protuberance within said second sectional member; and
causing said second protuberance to be selectively and frictionally fit within said first protuberance, thereby joining said second sectional member to said first sectional member and forming said laminate die.

10. The method of claim 9 further comprising forming an aperture in the first sectional member in an opposed surface of the first protuberance, the aperture being smaller than the second protuberance so that the second protuberance is frictionally fit within the aperture of the first protuberance.

11. The method of claim 9 further comprising:
forming the first protuberance of a first dimension; and
forming the second protuberance of a second dimension that is larger than the first dimension so that the second protuberance is frictionally fit within the first protuberance.

12. The method of claim 9 further comprising:
cutting the first sectional member from a generally planar laminate sheet; and
cutting the first protuberance into a perimeter of the first sectional member.

13. The method of claim 9 further comprising punching the first protuberance within the first sectional member.

14. The method of claim 9 further comprising:
determining that another sectional member is required;
forming a third sectional member;
forming a third protuberance within said third sectional member; and
causing said third protuberance to be selectively and frictionally fit within said second protuberance, thereby joining said third sectional member to said second sectional member.

15. A method for forming a laminated die comprising the steps of:
forming a first sectional member;
forming a second sectional member;
forming a hole within said first sectional member;
forming a protuberance within said second sectional member, unitary with said second sectional member; and
placing said protuberance within said formed hole, thereby joining said second member to said first sectional member and forming said laminated die.

16. The method of claim 15 further comprising forming the hole smaller than the protuberance so that the protuberance is frictionally fit within the hole.

17. The method of claim 15 further comprising:
cutting the second sectional member from a generally planar laminate sheet; and
cutting the protuberance into a perimeter of the second sectional member.

18. The method of claim 15 further comprising punching the hole within the first sectional member.

19. The method of claim 15 further comprising:
determining that another sectional member is required;
forming a third sectional member;
forming a second protuberance within said third sectional member; and
causing said second protuberance to be selectively fit within said protuberance of said second sectional member, thereby joining said third sectional member to said second sectional member.

20. A method for forming a laminated die comprising the steps of:
forming a first sectional member;
forming a first protuberance within said first sectional member;
forming a second sectional member;
forming a second protuberance within said second sectional member;
causing said first protuberance to be self aligned with said second protuberance; and
coupling said first sectional member to said second sectional member by a bonding agent after said first protuberance is self aligned with said second protuberance, thereby forming said laminated die.

21. The method of claim 20 further comprising:
placing an adhesive between the first sectional member and the second sectional member.

22. The method of claim 20 further comprising brazing the first sectional member to the second sectional member.

23. The method of claim 20 further comprising welding the first sectional member to the second sectional member.
